(19) United States
(12) Patent Application Publication
(10) Pub. No.: US 2015/0126260 A1
(43) Pub. Date: May 7, 2015

(54) SYSTEM AND METHOD FOR PROXIMITY AND MOTION DETECTION FOR INTERACTIVE ACTIVITY

(71) Applicant: LEVELUP INCORPORATED, Austin, TX (US)

(72) Inventor: David Michael Lynch, Dripping Springs, TX (US)

(21) Appl. No.: 14/504,332

(22) Filed: Oct. 1, 2014

Related U.S. Application Data
(60) Provisional application No. 61/898,486, filed on Nov. 1, 2013.

(51) Int. Cl. A63F 13/211; A63F 13/833; A63F 13/245

(52) U.S. Cl. CPC A63F 13/211; A63F 13/245; A63F 13/833
USPC 463/8

(57) ABSTRACT

A portable sword-type gaming device and method of using. The device including; a sword blade; a sensor system; a communications system; and a strike determiner receiving input from one or more of the sensor system and communications system to determine when the sword blade has made contact with another item; the strike determiner operable to determine whether the received input regarding blade contact is indicative of contact with another portable sword-type gaming device.

### PRIORITY

The present application is a non-provisional application of U.S. Provisional Application No. 61/898,486, filed Nov. 1, 2013, titled SYSTEM AND METHOD FOR PROXIMITY AND MOTION DETECTION FOR INTERACTIVE ACTIVITY, the disclosure of which is hereby expressly incorporated by reference and the priority of which is hereby claimed.

### FIELD OF THE DISCLOSURE

The present disclosure is related to methods and devices for physical and electronic interactivity that facilitate various entertainment implementations. More specifically, the present disclosure is directed to handheld gaming devices that wirelessly communicate and operate responsive to one or more of their physical orientation, location, velocity, acceleration, and those attributes relative to attributes of another similar gaming device.

### BACKGROUND AND SUMMARY

Gaming systems in the industry of video game entertainment often take the form of a controller and a console. Certain gaming systems combine the controller and console into an handheld gaming device. The video game is a feedback mechanism whereby a game player controls one or more elements on a screen via the controller. Some embodiments of video games employ a wireless controller with embedded accelerometers, gyroscopes, lasers, and infrared detectors to control the game on the video screen. Another embodiment uses a camera to detect the player's movements in the real world to control the game on the video screen. Systems having an immobile base and/or screen limit player's movements to an area within range of the console or screen on which the game is presented.

Handheld gaming devices, including phones and tablets have employed sensors, such as accelerometers, gyroscopes, proximity detectors, Global Positioning System (GPS), cameras and microphones. The mobile devices can take advantage of all of these sensors for game play, where the sensors of the device are used to control gameplay on the screen or speaker. With mobile gaming devices, game play is not limited to one area, but the game play feedback is provided by the onboard display of the mobile device and any given user's game play is limited to directly interacting with a single device.

According to a first embodiment, a portable sword-type gaming device is provided including; a sword blade; a sensor system; a communications system; and a strike determiner receiving input from one or more of the sensor system and communications system to determine when the sword blade has made contact with another item; the strike determiner operable to determine whether the received input regarding blade contact is indicative of contact with another portable sword-type gaming device.

According to another embodiment of the present disclosure, a method of monitoring interaction between multiple sword gaming devices including: providing a first sword gaming device including a sensor system; a communications system; and a strike determiner, determining, by the first sword gaming device, when the first sword gaming device has physically contacted another item; listening for an indication that another sword gaming device has physically contacted an item; and when an indication is received that the another sword gaming device has physically contacted an item, comparing details of the determined physical contact by the first sword gaming device with details of the physical contact by the other sword gaming device to determine whether the first and other sword gaming devices contacted each other.

### BRIEF DESCRIPTION OF THE DRAWINGS

The above-mentioned aspects of the present teachings and the manner of obtaining them will become more apparent and the teachings will be better understood by reference to the following description of the embodiments taken in conjunction with the accompanying drawings, wherein:

FIG. 1 is a plan view of sword-type device of the present disclosure;

FIG. 2 is a schematic view of electrical components within the sword of FIG. 1;

FIGS. 3a-d are illustrations of additional embodiments of devices able to be incorporated into system utilizing the electrical components of FIG. 2;

FIG. 4 is a flowchart showing exemplary operation of the device of FIG. 1;

FIG. 5 is a flowchart showing additional exemplary operation of the device of FIGS. 1; and

FIG. 6 is yet another flowchart showing exemplary operation of the device of FIG. 1.

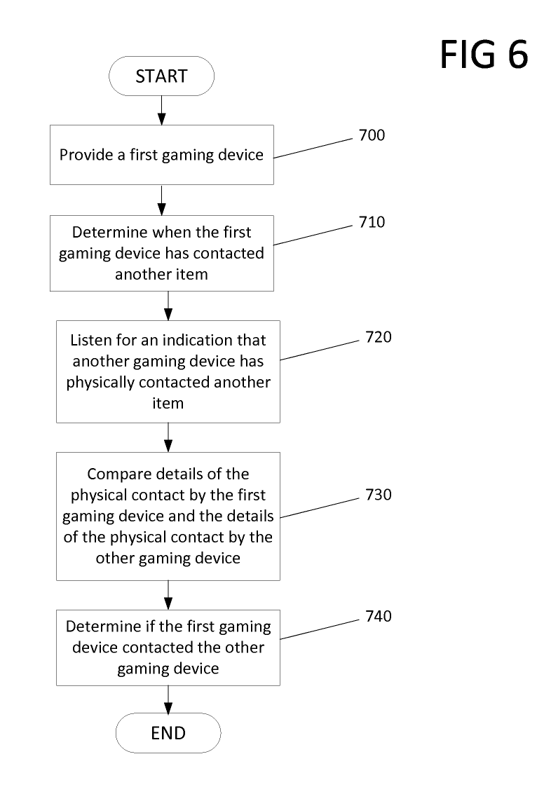

### DETAILED DESCRIPTION OF EMBODIMENTS

The embodiments disclosed herein are not intended to be exhaustive or limit the invention to the precise form disclosed in the following detailed description. Rather, the embodiments were chosen and described so that others skilled in the art may utilize their teachings.

The below description talks about items (such as swords 10) and also talks about players. Often reference to an item is used as a proxy to refer to a player and vise-versa. Thus, reference to a player may actually be a reference to an item held or associated with a player. One of skill in the art will readily understand that actions and properties attributed to a player are often determined by referring to attributes of an associated item (such as the player's sword 10). As an example, sensing the location of a player is actually sensing the location of a device associated with the player.

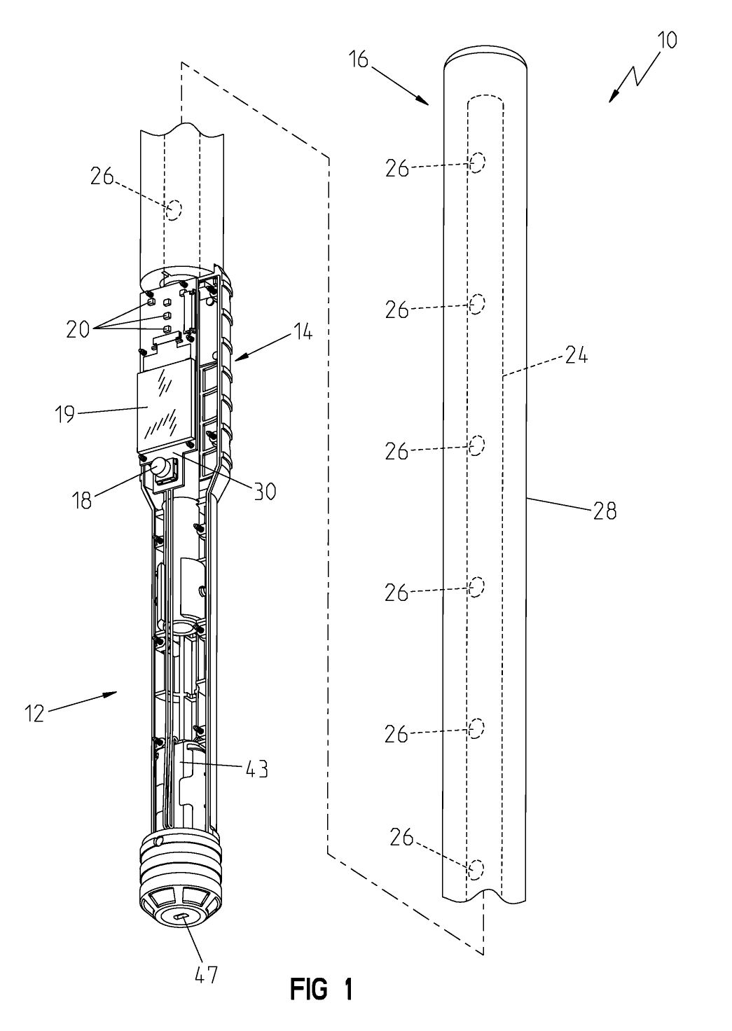

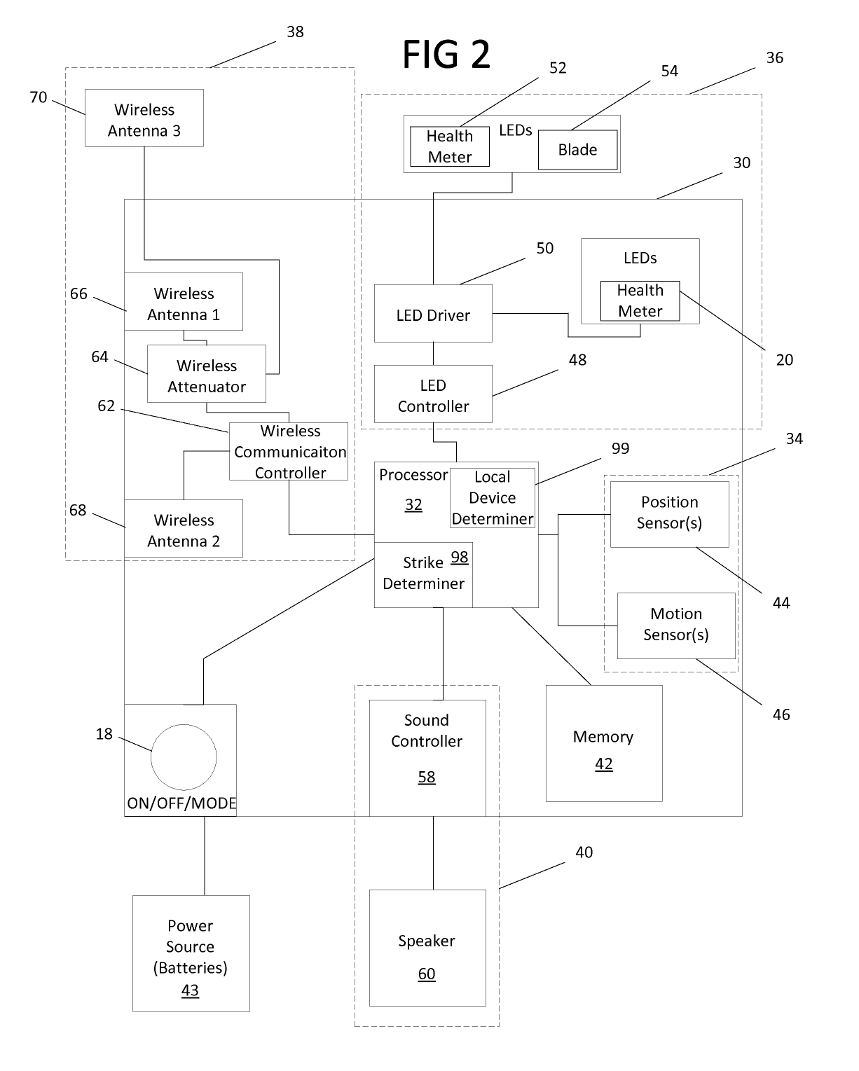

FIG. 1 shows sword 10 according to a first embodiment of the present disclosure. Sword 10 includes hilt 12, guard 14, and blade 16. Hilt 12 is illustratively constructed from plastic, but use of other materials is envisioned. Hilt 12 is illustratively a continuous piece with guard 14. Hilt 12 and guard 14 collectively include an interior portion that houses electronics, such as those shown in FIG. 2. Hilt 12 further includes an externally accessible power button 18. Guard 14 includes a plurality of externally perceptible lights 20.

In one embodiment, blade 16 is a two-part blade. The first part is a central cylindrical core 24 that is constructed from a relatively hard plastic. In one embodiment, core contains 24 one or more lights 26, such as a string of LED lights. The second part is an exterior part 28 illustratively made of closed cell foam that surrounds the first part (including an end cap). While closed cell foam is disclosed for exterior part 28, any material that is relatively soft and deformable while able to maintain its overall shape can be used. Furthermore, it should be appreciated that the stiffer cylindrical core 24 aids exterior part 28 in maintaining its shape. It should be appreciated that the specific construction of sword 10 is exemplary. Indeed, any construction of sword 10 is envisioned where the functionality described below is usable therewith.

FIG. 2 illustrates the electronics present in one embodiment of sword 10. The electronics of FIG. 2 are shown with some elements being on board 30 and other elements being off board 30. It should be appreciated that there may be multiple boards with different elements on each of the boards. Still further, embodiments are envisioned where elements shown off board 30 are actually on board 30. Accordingly, the presence of an element on board 30 is not intended to be limiting.

The electronics include processor 32, sensor system 34, lighting system 36, communications system 38, sound system 40, memory 42, and power source 43. Processor 32 is illustratively a processor commercially available under the name TINY GECKO sold by Silicon Labs. Processor 32 communicates and directs operations of sensor system 34, lighting system 36, communications system 38, sound system 40, and memory 42. Processor includes strike determiner 98 and local device determiner 99. Strike determiner 98 is illustratively processor 32 executing code. As will be discussed below in greater detail, strike determiner 98 processes input to determine when a strike has been landed (either on the player holding sword 10 or on another player). Local device determiner 99 is illustratively processor 32 executing code. As will be discussed below in greater detail, local device determiner 99 processes input to determine which external device (potentially of a plurality of external devices) is being interacted with (such as which device has either received or provided a determined strike).

Memory 42 can either on processor 32, off processor 32, or a combination thereof. Memory 42 illustratively holds programming instructions thereon that when interpreted by processor 32 cause operation as described herein.

Sensor system 34 illustratively includes position (proximity, orientation) sensor(s) 44 and motion sensors(s) 46. As will be discussed further herein, certain portions of communications system 38 also serve a sensor function. Position sensors are illustratively gyroscopes, GPS chips, laser range finders, barometers, radio triangulation devices, ultrasonic triangulation devices, infrared triangulation devices, or any other electronics capable of producing an output from which positioning information (including relative position to other swords 10 and items) can be determined. Embodiments are also envisioned without position sensors. Motion sensors 46 are illustratively accelerometers, gyroscopes, magnetometers, or any other electronics capable of producing an output from which movement information can be determined.

Lighting system 36 includes LED controller 48, LED driver 50, first health meter LEDs (plurality of externally perceptible lights 20); second health meter LEDs 52, and blade lights 54. It should be appreciated that while LED's have been chosen for their robustness (ability to sustain and survive impact accelerations) and their relatively low power draw, other lighting can be used within the scope of this disclosure. LED controller 48 is in communication with processor 32. Upon instructions from processor 32, LED controller 48 sends signals to LED driver 50 to selectively operate LEDs 20, 52, 54. In the illustrated embodiment, LEDs 20 and 52 are identical yet positioned on opposite sides of hilt 12 to provide multiple viewing angles and easier communication of the information provided thereby. LEDs 20 and 52 are illustratively each as set of three LEDs intended to indicate levels of health for the wielder of the sword 10. It should be appreciated that differing manners of communicating health can be used such as one or more lights that change colors to indicate health, more or less than three lights to provide more or less than three health levels, a bar that is fully lit to show full health but then becomes partially lit to show partial health (and ultimately dark to show no health), lights that show different intensity to show differing health levels, and any other manner of communicating health levels via lights. Blade lights 54 illustratively are disposed within core 24 of blade 16. In embodiments with blade lights 54, core 24 and exterior part 28 are translucent such that light produced by blade lights 54 is externally perceptible. Blade lights 54 are illustratively operated to indicate when a game objective is met (or can be constantly on during use, but then flashed to indicate a game objective). Examples of game objectives include but are not limited to scoring a “hit” on an opponent and winning a game. The conditions that lead to achieving an objective are discussed below in greater detail.

Sound system 40 includes sound controller 58 and speaker 60. Sound controller 58 receives input from processor 32 and responsively outputs signals to speaker 60 to create audible sound. The created sound can take the form of instructions to a user, sound effects for game action, indication of achieving a game objective, health status, or otherwise.

Communications system 38 includes wireless communication controller 62, wireless attenuator 64, and one or more antennae 66, 68, 70. Wireless communications controller 62 receives input from processor 32, directs output of information over antennae 66, 68, 70 and provides data received from antennae 66, 68, 70 to processor 32. Wireless communications controller 62 illustratively operates according to an RFID, NFC, Wi-Fi, Bluetooth, audible sound, inaudible sound (such as ultrasound), infrared, capacitive and inductive coupling, or other wireless protocol. However, other wireless protocols are envisioned. In one embodiment, a 2.4 GHz ZigBee protocol is used. Bluetooth communication is also used that provides for communication with a user's cell phone. Wireless attenuator 64 logically sits between wireless communications controller 62 and each of antenna 66 and antenna 70. Such placement of wireless attenuator 64 provides that antenna 66 and antenna 70 are attenuated antennas. Being attenuated provides that their ability to broadcast a signal and to receive and provide a signal to processor 32 is more limited relative to non-attenuated antenna 68. It should be appreciated that the amount of attenuation is illustratively a variable setting that is set at least partially dependent by the instructions being interpreted by the processor and the particular implementation (such as a particular game) being run. In at least one embodiment, the communications system operates to determine when other swords 10 (or other game implements) are present and as such acts as a sensor sensing other game implements. In such embodiments, the non-attenuated antenna 68 is able to sense a larger area for other game implements than attenuated antennae 66, 70. As such, detection by antenna 68 may indicate presence of a game implement within a game zone (or arena) while detection of a game implement by an attenuated antenna 66, 70 may indicate presence of the game implement within the immediate vicinity of sword 10 and may be interpreted to indicate that sword 10 is interacting with the detected game implement as discussed further herein.

Power source 43 is illustratively a battery. In one embodiment, power source is a rechargeable battery and includes a port for a plug such that the battery can be recharged via being plugged into a wall socket. Still further, embodiments are envisioned where power source 43 can be recharged via USB port 47 on hilt 12 (or elsewhere). In such embodiments, USB port 47 can also provide access to memory 42 to provide software and/or firmware updates to load new game modes or other data or to retrieve data from memory 42. It should be appreciated that embodiments are also envisioned where such data exchanges are provided via communications system 38 or otherwise. Also, embodiments are envisioned where the device (sword 10 or otherwise) is wirelessly charged. Such embodiments illustratively use an inductive coil for charging. Furthermore, devices, such as darts can utilize ambient radio waves to derive power. Powering of such devices is akin to RFID-like interactions. Such devices can further be powered by stray WiFi signals. Such devices can be passive and be free of an internal battery.

Power button 18 illustratively is a press-button that turns on and off sword 10. In one embodiment, power button 18 is a capacitive touch switch. Button 18 may interrupt power from power source 43 to processor 32 or rather may not directly interrupt power flow to processor but just serve to bring processor 32 (and sword 10 generally) into and out of a sleep mode having reduced or no power draw. Still further, embodiments are envisioned where a sustained press of button 18 is needed to turn sword 10 on and off, but shorter presses cause sword 10 to switch between operational modes (games). The particular mode currently invoked can be communicated to a user via lighting system 36 and/or sound system 40. Embodiments are envisioned where additional externally accessible buttons are provided for additional switching functionality and where other sensors, such as motion sensor 46, can be used to generate input, such as game mode selections. In the illustrated example, touchscreen 19 is provided to allow users to interact with sword 10 and choose game options.

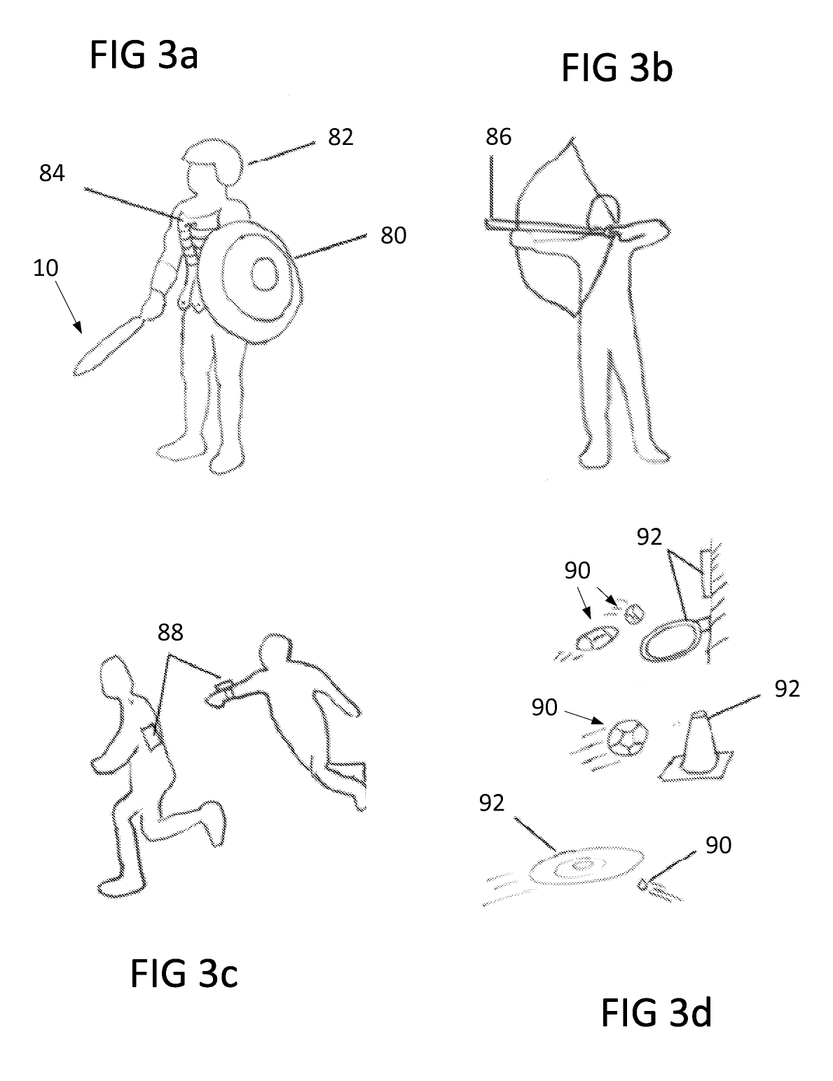

FIGS. 3a-d show additional exemplary objects that may contain all or a subset of the above electronics. FIG. 3a shows sword 10, shield 80, helmet 82, and body armor 84. Shield 80, helmet 82, and armor 84 illustratively contain (or share) at least a sensor system 34 and a communications system 38. FIG. 3b shows arrow 86 that illustratively contains at least a sensor system 34 and a communications system 38. FIG. 3c shows wearable proximity detectors 88 that detect when two players are close enough to each other to perform an electronic “tag.” Such a tag need not entail actual physical contact between two items. Each proximity detector 88 illustratively contains at least a sensor system 34 and a communications system 38. FIG. 3d shows various embodiments for other games involving throwable objects such as balls 90 that all illustratively contain at least a sensor system 34 and a communications system 38. Balls 90 are able to be used with stationary or moving elements 92. Also, various items (carryable pucks, fixed location pucks, or any item) are envisioned where being in proximity to such item affects the sword 10 or other devices (by increasing damage scored by sword 10, by doubling scoring of a ball 90, by negating damage inflicted by others on the user possessing such item, enhancing effects of armor 84, or otherwise enhancing or detracting from properties and effects within a game, similar to the concept of “power-ups” in video games).

Having described the devices and their physical makeup, exemplary uses of the devices (sword 10, helmet 82, body armor 84, shield 80, arrow 86, wearable proximity detectors 88, balls 90, elements 92) will now be discussed, including programming invoked to provide enhanced functionality to the devices. It should be appreciated that while the functionality will be discussed by reference to various games played therewith, many more games are envisioned that utilize some or all of the functionalities described herein.

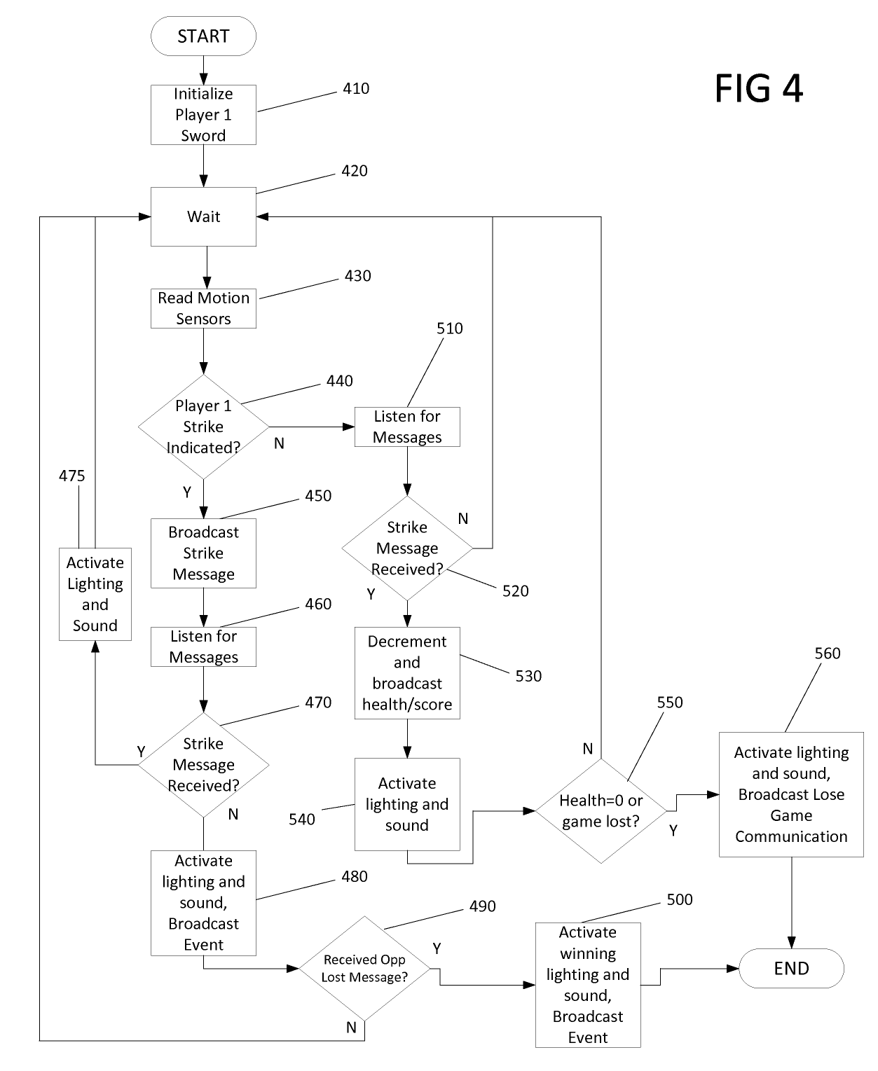

FIG. 4 shows operations performed by the electronics of sword 10 at the direction of processor 32 interpreting instructions to enact game play. A first embodiment of game play involves two players, each with their own sword 10, block 700. Each sword 10 operates according to the flowchart of FIG. 4. The description below is from the perspective of a first player (Player 1) playing against a second player (Player 2) with a second sword 10.

Upon startup of sword 10, the electronics initialize, block 410. Initialization includes sending power to each subsystem 32, 34, 36, 38, 40, 42 and obtaining information regarding the instructions to be processed by processor 32 (the game mode in which to operate). The system then waits a set amount of time, block 420. This time can be very short (less than one second) or can be set to higher values to increase battery life or for any other desired reason. Processor 32 the queries sensor system 34 to obtain data therefrom, block 430. Strike determiner 98 then analyzes the data to determine whether the data indicates that sword 10 has struck something, block 440, 710. One exemplary signal that could be held to be indicative of a strike is a sharp acceleration signal spike. Swinging sword 10 would involve acceleration. However, hitting something else would be expected to generate a sharp deceleration. Similarly, blocking a blow of another sword 10 may involve a quick acceleration in sword 10. Accordingly, in one embodiment, block 440 looks for a sharp acceleration experienced by sword 10. Other embodiments are envisioned where an onboard gyroscope and/or barometer is consulted to see the attitude and/or height of sword 10. If the input from the gyroscope determines that the sword is pointed down, strike determiner 98 may determine that a sharp acceleration is likely due to blade 16 striking the ground or striking a lower portion of another player (which may be disallowed due to wanting to discourage low hits). Accordingly, strike determiner 98 may use sensor system 34 to further refine what conditions generate a “valid” strike and may use different criteria to define a strike and a “valid strike.”

Upon determining that sword 10 has struck something, an indication of the strike is provided to communications system 38 and broadcast on one or more antennae 66, 68, 70, block 450. Processor 32 then queries communications system 38 (or waits/listens for data from communications system 38) to see if communication is received from another sword 10 (of Player 2) indicating that the other sword also experienced a strike, block 460, 720. If it is determined that such a communication has been received, block 470, and that the details of the communicated strike are similar in character (time, force, etc.), block 730, then strike determiner 98 determines that two swords 10 likely made contact with each other, block 740. This condition is assumed to be indicative of one sword blocking another such that no point is awarded to either player (no health point is taken from either player). Selected lighting and sound is then activated, such as a “clash” sound, block 475. The system then returns to block 420. In certain embodiments, listening for communications of strikes from other devices is performed using attenuated antennae 66, 70 to provide that only strikes that are possibly strikes against the sword 10 of the player in question are considered. In another embodiment, a single-point-of-contact network can be established between two swords when they both come into physical contact. Such an embodiment need not use output from an accelerometer. This embodiment utilizes a high-impedance electrical connection where the swords communicate by physically touching each other. Processor 32 can tell if it was completing the circuit sword-to-sword or sword-to-player by the time domain reflection (TDR) of the transmitted signal. This embodiment illustratively uses direct high-impedance electrical connection with only a single conductor within sword 10 to determine strikes.

If no strike message is received from another sword 10 (Player 2), then sword 10 is determined to have made contact with a portion of Player 2 other than his sword, block 730. This condition results in a point being awarded to Player 1 (and/or the health of player 2 being decremented). One or more of lighting system and sound system are invoked to provide an indication that Player 1 has landed a scoring blow and a communication of the landed blow is broadcast, block 480.

Processor 32 then determines if communications system 38 has received/detected a game won/lost message indicative of Player 2 having their health fully depleted, block 490. If no such communication has been received/detected, then the system returns to wait, block 420. If the game won/lost message has been received/detected, then processor 32 activates one or more of lighting system 36 and sound system 40 to indicate that Player 1 has won and a communication is broadcast indicating the win, block 500.

Returning to block 440, if no strike by Player 1 is detected, processor 32 determines whether sword 10 of Player 2 has issued a strike message (via Player 2's sword performing block 450), block 510. If it is determined, block 520, that no such strike message is received then processor 32 returns to wait, block 420. However, if it is determined, block 520, that a strike message is received, then strike determiner 98 assumes that sword 10 of Player 2 has struck Player 1. In some embodiments, the proximity detection disclosed herein can also be used to ensure that another sword 10 is within range of the sword 10 assumed to have landed a strike. In response to being struck, the health of Player 1 is decremented and communications system 38 emits a signal that indicates that Player 1 has lost a health point (or generally has been struck), block 530. Processor 32 then causes one or more of lighting system 36 and sound system 40 to indicate that Player 1 has been struck and/or lost a health point, block 540.

Processor 32 then determines whether Player 1's health has been fully depleted or whether Player 1 has otherwise been determined to have lost the game, block 550. If not, processor 32 returns to block 420 and the game continues. If Player 1 is determined to have lost, processor 32 instructs one or more of lighting system 36 and sound system 40 to enact “game lost” lighting and/or sounds. Processor 32 further instructs communications system 38 to emit a signal indicating that Player 1 has lost, block 560. This signal is one that is received by Player 2's communications system and detected by Player 2's processor performing block 490. With a player determined to be the winner and a player determined to be the loser, the game ends.

It should be appreciated that embodiments are envisioned communications system 38 sends out signals on multiple antennas for different intended recipients. Indeed, while certain signals are intended for another sword 10 (or other game elements) other signals may be intended for a game server that is able to receive signals, and control/score the game. Still further, the game server may emit signals to be received by swords 10 (or other game elements) to impact their operation or game play.

Also, variations on the gameplay shown in FIG. 4 include the use of armor 84, helmet 82, shield 80, and similar items. In such variations, items 80, 82, 84 also elicit signals indicative of when they are hit such that a hit to one of these items would equate to a block by sword 10 or reduce the damage (loss of health) experienced due to such a hit.

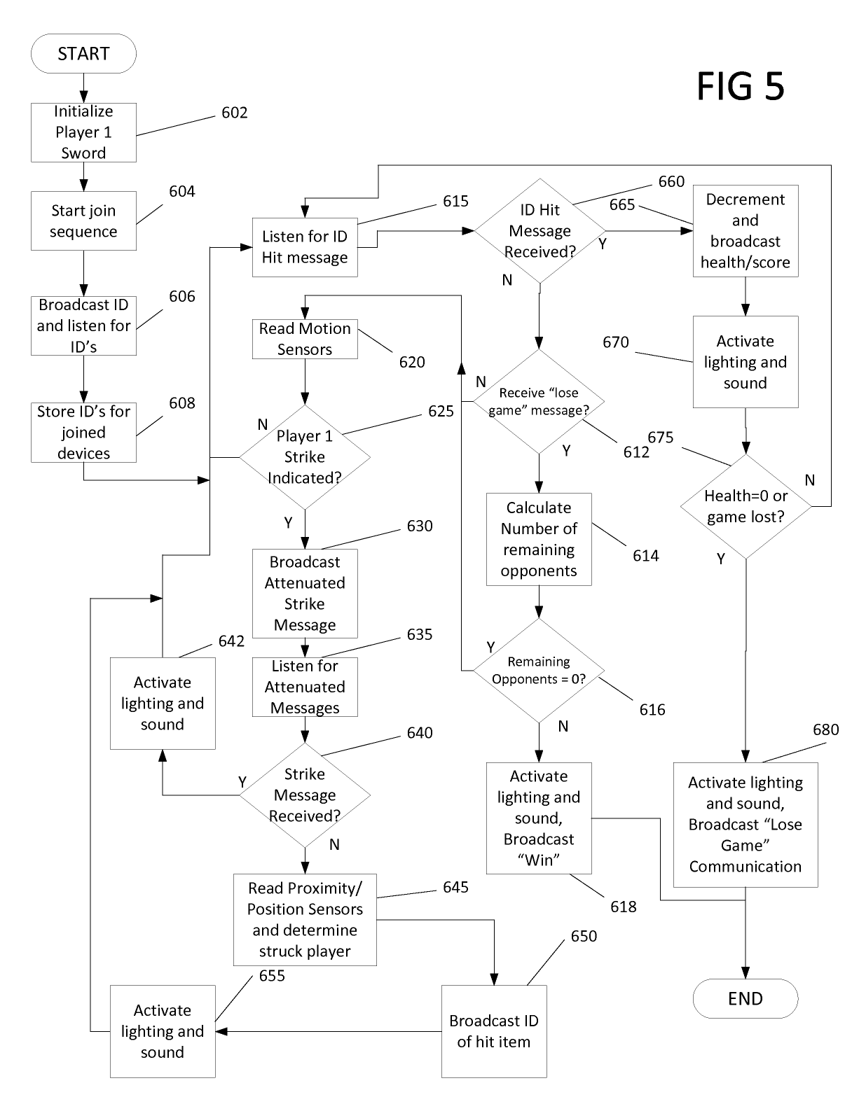

FIG. 5 shows operations performed by the electronics of sword 10 at the direction of processor 32 interpreting instructions to enact another embodiment of game play. This embodiment includes greater than two players and is generally referred to as a “melee mode.” In melee mode Player 1 is competing against all other players provided a sword, block 700. Additional variants of melee mode are anticipated where Player 1 is part of a team that is competing against another team. Such team modes can include games such as “capture the flag” where the designated “flag” has onboard electronics that allow it to interact with other items and where the position of the flag is monitored relative to other items and relative to various monitored locations on a game field. Furthermore, games are envisioned that are similar to traditional laser tag games and include one or more base stations that a user must visit to “recharge” their health. Games with increased number of players and/or game pieces may see increased utility in a server that is able to monitor the gaming pieces and present a more universal view of the dispositions and conditions of all pieces in play.

Upon startup of sword 10 in melee mode, sword 10 again initializes to power up processor 32, memory 42, and systems 34, 36, 38, 40, block 602. Upon instruction from a user, sword 10 then starts a join sequence to indicate that sword 10 desires to start and/or join a melee melee game, block 604. Sword 10 broadcasts its ID and listens for other ID's of swords that intend to be part of the melee. Furthermore, whenever another sword 10 is detected, sword 10 illustratively emits its own ID again or emits a signal that provides ID's of all joined swords, block 606. The IDs that are received are stored on sword 10, block 608. After a set amount of time or an indication by a user that all swords are joined, the game is commenced.

Processor 32 the proceeds to determine if a signal has been emitted from anywhere (another sword or item, or controlling server) that indicates a hit associated with a unique ID associated with itself (Player 1), block 615. The unique ID is illustratively such an ID as is commonly used in RFID technology.

If no hit message is received, processor 32 listens to see if a “lose game” message has been sent out by any other sword 10, block 612. If no such message is received, processor 32 (and strike determiner 98) monitors sensor system 34, block 620, to determine if a strike by Player 1 has occurred, block 625, 710. If no strike is sensed, processor 32 returns to block 615 and listening for an indication that a hit has been landed on player 1.

If it is determined that a strike has been made by Player 1, block 625, then a communication of that fact is emitted, block 630. This communication is illustratively emitted over one of antennae 66, 70 which are attenuated. Because melee mode anticipates multiple swords 10 in play, many of which may be far afield and not in proximity or contact with one another, a general signal of a strike by sword 10 of Player 1 that reaches all swords 10 is not desired.

Sword 10 of Player 1 then listens for communications from other swords 10 indicating strikes by said other swords 10, block 635. Sword 10 of Player 1 is illustratively listening for attenuated communications indicating strikes. In one embodiment, different antennae operate according to different protocols or different frequencies.

If a strike message is received from an adjacent sword 10, block 640, 720, then assuming the characteristics of the strikes sufficiently match, block 730, the strike of Player 1's sword 10 and the adjacent sword 10 are determined to be offsetting, block 740. Lighting and/or sound is activated, block 642, and processor 32 returns to listen for ID hit messages, block 615. Again, embodiments are envisioned where other means of determining whether a strike is to another sword 10 or to a player are envisioned. Indeed, in one embodiment, wireless antenna 70 is positioned at a distal end of blade 16 and the differential in signals received at or from antennae 66, 70 are used in such a determination. Still further, the use of additional sensors, such as but not limited to pressure sensors, contact switches, deformation switches (wires in the foam of exterior part 28 of blade 16 that cause a change in capacitance when deformed to indicate a strike) is envisioned. It should further be appreciated that the attenuation can assume multiple values such that the area and reach of the signal is variable (either by the manufacturer or the user) to achieve desired sensitivity as desired.

If no strike message is received from an adjacent sword 10, block 640, then Player 1 is determined to have landed a scoring blow. Local device determiner 99, of sword 10 of Player 1 then determines what other players (or devices 80, 82, 84, etc.) are nearby by sensing adjacent swords (or devices). In the illustrated example, this is done via local device determiner 99 querying or receiving information from sensor system 34 and proximity/position sensors to determine the likely player or device on which the scoring blow was landed, block 645. In one embodiment, one “opponent ID” (or device ID) is chosen from among multiple detected “opponent ID's” based upon signal strength received therefrom. In such embodiments, each sword 10 may be set to have a constant ID broadcast signal strength to allow the detection of signal strength to have increased accuracy for determining a closest opponent or device. It should be appreciated that embodiments are anticipated utilizing any available system or method for determining proximity of opponents. These systems/methods include but are not limited to RSSI, link quality, energy detection, indoor GPS (triangulation), infrared, ultrasound, lasers, capacitive coupling, and inductive coupling.

Once the struck player is determined, an identification of the struck player is wirelessly broadcast, block 650. In one embodiment, this broadcast includes a unique ID that identifies the sword 10 of the struck player. This broadcast is intended to be received by one or more of the sword 10 of the player that was struck and any system that is keeping track of the overall melee. This broadcast signal is the signal being listened for in block 615 and 660. Once the broadcast is sent (or before or simultaneously therewith) lights and/or sounds are activated on sword 10 of Player 1 to indicate that a scoring blow was landed, block 655.

When a message is detected that indicates that the player holding sword 10 (such as Player 1) was subjected to a scoring blow, block 660, sword 10 (of Player 1) notes that a scoring hit was lodged against its player and decrements health/score associated therewith, block 665. In some embodiments, sword 10 also broadcasts a signal indicating remaining health/score. If there is an outside system keeping track of the overall melee, this broadcast may not be necessary. Sword 10 also activates one or more of lighting and sound to indicate that a scoring blow has been lodged against the player associated with sword 10, block 670.

Sword 10 then checks whether the received blow fully depletes the health score associated therewith or otherwise indicates that the player holding sword 10 has lost, block 675. If there is no loss condition active, then sword 10 continues to block 615 to listen for hit messages and sense landed strikes. If the loss condition is determined, then additional lighting effects and/or sound effects are produced to indicate the loss condition, block 680. Sword 10 that determines a loss condition is active further transmits an indication of its loss condition. Such communication illustratively includes a unique ID of the sword 10 issuing the transmission such that receiving entities know that a particular sword is “out.”

If a system element is monitoring the overall melee and determines that all but one participating swords 10 has issued a loss signal, the monitoring system element can transmit a signal to the surviving sword 10 indicating victory. The victorious sword 10 would then activate lighting and/or sounds to indicate the victory. Still further, sword 10 can store an indication of such victory for games where an overall victory is predicated upon achieving multiple victories (e.g. first player to 3 melee victories, or best 3 of 5 in 1-on-1 battles). In other embodiments, such as those without the overall monitoring device, sword 10 continues to emit a signal (non-attenuated) of its unique ID for so long as it is a participant in the game and has not satisfied the loss condition. Accordingly, when no other broadcast sword ID is detected and sword 10 has not satisfied the loss condition, sword 10 assumes it has won the melee and responds via one or more of lights and sounds to indicate a victory.

Alternatively, when receiving a “lose game message” at block 612, sword 10 calculates a number of remaining opponents, block 614, with reference to the stored ID's of block 608. Sword 10 (processor 32) determines if there are any remaining opponents, block 616. If there are remaining opponents, sword 10 continues to read motion sensors, block 620. If there are no remaining opponents, sword 10 enters a win mode, activates lighting and/or sound and broadcasts an indication that win mode has been achieved, block 618.

It should further be appreciated that lighting and sounds can be triggered off of any combination of inputs available to processor 32. In one example, lighting and sound effects are provided when multiple blades increase in proximity, regardless of actual contact being made. Indeed, full game modes can be implemented that are based off proximity sensing without requiring actual contact. More specifically, in games involving balls 90 and the like, (such as soccer balls), scoring would be determined by the ball being located within a goal rather than contacting anything. Further, in games such a curling, automatic sensing of proximity of a stone to the button provides scoring information.

Additionally, while swords 10 have been described herein as having a plurality of sensing and communication features, economy models are envisioned that have less than all the described features. In one embodiment, a sword 10 has a simple motion sensor (such as a “rattle switch”) and communicates with other swords via IR. Specifically, in a two player mode, proximity sensors are not necessary to differentiate between multiple potential opponents.

Other game modes include “one hit to win,” games where the force of a hit can result in more or less damage being reflected in an opponent's health, games where depleted health is regained via the passing of time or sword-on-sword contact, and where hits on players with lower health remaining result in lower damage being inflicted for a hit. Additionally, modes are envisioned where a player needs to hold sword 10 very still (or alternatively keep it in motion) to regain health (or prevent the losing of health). Such modes can be set to be temporary (limited time) or can be a length-of-game feature.

Accordingly, it should be appreciated that the above systems provide for distributed handheld electronic items to self-govern in games and provide for interactivity with other similar items without a central master control device that elicits instructions to the distributed pieces. Furthermore, the distributed pieces interact dependent upon their placement in space and physical operations performed by and on them. The distributed pieces further interact electronically dependent upon physical interaction between said pieces.

The above detailed description and the examples described herein have been presented for the purposes of illustration and description only and not for limitation. For example, the operations described may be done in any suitable manner. The method may be done in any suitable order still providing the described operation and results. It is therefore contemplated that the present embodiments cover any and all modifications, variations or equivalents that fall within the spirit and scope of the basic underlying principles disclosed above and claimed herein. Furthermore, while the above description describes hardware in the form of a processor executing code, hardware in the form of a state machine, or dedicated logic capable of producing the same effect are also contemplated.

The software operations described herein can be implemented in hardware such as discrete logic fixed function circuits including but not limited to state machines, field programmable gate arrays, application-specific circuits or other suitable hardware. The hardware may be represented in executable code stored in non-transitory memory such as RAM, ROM or other suitable memory in hardware descriptor languages such as, but not limited to, RTL and VHDL or any other suitable format. The executable code when executed may cause an integrated fabrication system to fabricate an IC with the operations described herein.

Also, integrated circuit design systems/integrated fabrication systems (e.g., work stations including, as known in the art, one or more processors, associated memory in communication via one or more buses or other suitable interconnect and other known peripherals) are known that create wafers with integrated circuits based on executable instructions stored on a computer readable medium such as, but not limited to, CDROM, RAM, other forms of ROM, hard drives, distributed memory, etc. The instructions may be represented by any suitable language such as, but not limited to, hardware descriptor language (HDL), Verilog or other suitable language. As such, the logic, software and circuits described herein may also be produced as integrated circuits by such systems using the computer readable medium with instructions stored therein. For example, an integrated circuit with the aforedescribed software, logic and structure may be created using such integrated circuit fabrication systems. In such a system, the computer readable medium stores instructions executable by one or more integrated circuit design systems that causes the one or more integrated circuit design systems to produce an integrated circuit.

What is claimed is:

1. A portable sword-type gaming device including;
a sword blade;
a sensor system;
a communications system; and
a strike determiner receiving input from one or more of the sensor system and communications system to determine when the sword blade has made contact with another item; the strike determiner operable to determine whether the received input regarding blade contact is indicative of contact with another portable sword-type gaming device.

2. The device of claim 1, wherein the communications system is operable to emit a first communication indicative of input from the sensor system indicating that the sword blade has made contact with another item.

3. The device of claim 2, wherein the communications system listens for first communications emitted from other sword-type gaming devices.

4. The device of claim 2, wherein the strike determiner determines that input regarding blade contact is indicative of contact with another portable sword-type gaming device when a first condition is satisfied, the first condition being selected from: 1) receiving a first communication from another gaming device within a predefined period of time of receiving input from the sensor system indicating blade contact, 2) determining that a second sword is within a pre-defined proximity of the first sword, and 3) a direct high-impedance electrical connection with only a single conductor indicates contact with another sword-type gaming device.

5. The device of claim 1, further including a battery in the gaming device that powers the gaming device.

6. The device of claim 1, further including a housing that couples to the sword blade, houses at least a portion of the sensor system, houses at least a portion of the communications system, and houses the strike determiner.

7. The device of claim 6, further including externally perceptible indicators in the housing operable to communicate scoring to one or more users.

8. The device of claim 7, wherein the indicators provide one or more of audio and visual indicators.

9. The device of claim 1, further including a proximity sensor; the proximity sensor providing for determining which of a plurality of gaming devices is closest to the sword-type gaming device at the time that blade contact by the sword-type gaming device is indicated.

10. The device of claim 9, wherein the device is operable to generate one or more of lighting and sound in response to input received from the proximity sensor.

11. The device of claim 1, wherein the communication system is a wireless communication system.

12. A method of monitoring interaction between multiple sword gaming devices including:
providing a first sword gaming device including a sensor system; a communications system; and a strike determiner,
determining, by the first sword gaming device, when the first sword gaming device has physically contacted another item;
listening for an indication that another sword gaming device has physically contacted an item; and
when an indication is received that the another sword gaming device has physically contacted an item, comparing details of the determined physical contact by the first sword gaming device with details of the physical contact by the other sword gaming device to determine whether the first and other sword gaming devices contacted each other.

13. The method of claim 12, wherein when no indication is received that another sword gaming device physically contacted another item, determining which sword gaming device of a plurality of sword gaming devices is located closest to the first sword gaming device.

14. The method of claim 13, further including determining that the first sword gaming device contacted a user of the closest other sword gaming device.

15. The method of claim 12, wherein the sensor system includes an accelerometer and determining when the first sword gaming device has physically contacted another item uses an output from the accelerometer.

16. The method of claim 12, wherein upon determining, by the first sword gaming device, that the first sword gaming device has physically contacted another item; emitting a wireless signal indicative that the first sword gaming device physically contacted another item.

17. The method of claim 12, wherein upon receiving an indication that another sword gaming device has physically contacted an item and determining that the first sword gaming device did not physically contact an item, determining that a scoring blow has been received by the user of the first sword gaming device.

18. The method of claim 17, further including reducing a score associated with the first sword gaming device.

19. The method of claim 17, further including determining if such scoring blow results in a loss scenario associated with the first sword gaming device.

20. The method of claim 19, further including that a communication is emitted indicating a loss scenario for the first sword gaming device upon determining that the loss scenario is in effect on the first sword gaming device.

21. The method of claim 17, wherein determining that a scoring blow has been received by the user of the first gaming device is performed by determining that the first sword gaming device is a sword gaming device of a plurality of sword gaming devices most closely located to the sword gaming device to the another sword gaming device that physically contacted an item.
